(19) United States
(12) Patent Application Publication
(10) Pub. No.: US 2002/0089807 A1
(43) Pub. Date: Jul. 11, 2002

(54) Polymer electrochemical capacitors

(75) Inventors: Alexander Bluvstein, Dimona (IL); Tatyana Zilov, Arad (IL); Gregory Gildingersh, Dimona (IL)

Correspondence Address: LERNER, DAVID, LITTENBERG,, KRUMHOLZ & MENTLIK, 600 SOUTH AVENUE WEST, WESTFIELD, NJ, 07090, US

(73) Assignee: ELESTOR Ltd.

(21) Appl. No.: 09/925,719

(22) Filed: Aug. 9, 2001

(30) Foreign Application Priority Data
Aug. 10, 2000 (IL) 137796

(51) Int. Cl. H01G 4/35; H05K 1/11

(52) U.S. Cl. 361/302

(57) ABSTRACT

The invention provides an electrochemical capacitor which comprises positive and negative electrodes made of conducting p-dopable polyaniline, directly polymerized on high porosity carbon substrates and a polymer electrolyte layer, comprising a polymer matrix and a ionic conductive compound. The capacitor further comprises two outer conductive layers, a spacer for creating a gap between the electrodes, and sealing means.

A method of making the capacitors is disclosed, which comprises effecting chemical or electrochemical polymerization of the aniline over the substrate.

The electrochemical capacitors of the invention are simple to manufacture and require the use of cheap materials only. They have a higher specific capacitance and a higher energy density than the prior art electrochemical capacitors.

### FIELD OF THE INVENTION

This invention relates to electric charge storage devices, particularly to electrochemical capacitors, based on a p-doped conducting polymer as active material, and to a method for their manufacture.

### BACKGROUND OF THE INVENTION

Electrochemical capacitors are devices that store electrical energy at the electrode/electrolyte interface, which may be combined with Faradaic charge of redox reactions. This type of energy storage has become technologically interesting with the application of new materials with very active surfaces, e.g., activated carbon materials, electroactive conducting polymers, and certain transition metal oxides.

The main advantages of electrochemical capacitors in comparison with batteries are a much higher rate of charge-discharge (power density) and excellent cycle durability which may be higher than 10⁵ cycles. The materials with high charge density can contribute to miniaturization of electrochemical capacitors and, therefore, to a variety of mobile devices and apparatus, for example, notebook PCs, cellular phones, VCRs, automotive subsystems, electric vehicles, etc. Most of the electroactive polymers can be generated at a conducting state by chemical or electrochemical oxidation, which induces positive charges (p-doping) into the polymer chains. Charge storage mechanism in conducting polymers is complex and is thought to be a combination of redox capacitance and double layer capacitance components.

U.S. Pat. No. 5,284,723 discloses electrochemical energy storage devices, which can be used as super capacitors or as rechargeable generators, containing a composition comprising an electrically conductive polymer based on polypyrrole, optionally substituted, and ionic groups which comprise alkyl- or aryl- sulfate or sulfonate groups.

U.S. Pat. No. 5,442,197 discloses a super capacitor comprising a positive and a negative electrode having a potential, both made of a p-doped electron conducting polymer, and electrolyte which comprises an organic redox compound.

U.S. Pat. No. 5,626,729 discloses electrode assembly for electrochemical capacitor devices which comprises a titanium or stainless steel substrate having a nitride layer formed on the surface thereof, and a layer of polyaniline deposited on said nitride layer.

U.S. Pat. No. 5,714,053 discloses a method of fabricating an electrochemical capacitor which comprises forming a first electrode on a substrate via constant current electrolysis of an electrically conducting polymer in contact with a soft anion, treating it with a solution including a hard anion, and assembling said electrode, a second electrode, an electrolyte layer and a substrate, to form an electrochemical capacitor.

U.S. Pat. No. 5,733,683 discloses an electrochemical storage cell or battery including, as at least one electrode, at least one electrically conductive polymer, chosen from a number of derivatives of thiophene.

U.S. Pat. No. 5,811,205 discloses an electrode containing a non-aqueous liquid electrolyte and comprising an electronically conducting porous first layer including at least one first face covered with a microporous second layer, constituted by a polymeric material, said second layer being produced by coagulation of a polymer from a solution thereof impregnating said first face.

U.S. Pat. No. 5,527,640 discloses an electrochemical capacitor having, in the charged state, a positive electrode including an active p-doped material and a negative electrode including an active n-doped conducting polymer, wherein the p-doped and n-doped materials are separated by an electrolyte. Said patent, in its discussion of the prior art, which is incorporated herein by reference, discusses the nature of charged storage within conducting polymers, which is considered as being a mixture of Faradaic and capacitive components. It distinguishes three types of electrode configurations forming a unit cell in the capacitor. In type I, both electrodes contain the same amount of a same p-dopable conducting polymer. In type II, two different p-dopable conductive polymers form the electrodes. In type III, each conductive polymer is in its conducting doped state when the capacitor is fully charged, one polymer being n-doped and one p-doped. The prior art is said to disclose all three types of configurations.

In type I, in which both electrodes are prepared from the same p-dopable polymer, the operating voltage is relatively low. In type II, wherein two different p-dopable polymers with different potential ranges of oxidation-reduction are used, the operating voltage is somewhat higher than that of type I. Type III capacitor systems offer a substantially wider range of operating voltage of about 3 V in non-aqueous electrolytes, and consequently an increased energy density (calculated per gram of active material).

The energy density of the electrochemical capacitor is not dominated exclusively by specific capacitances of active materials, but by an electrolyte contribution and type of the capacitor system as well (C. J. P. Zhing et al., “The Limitations of Energy Density for Electrochemical Capacitor”, J. Electrochem. Soc. 144, No. 6, pp. 2026-2031 (1997)). In type I capacitors, to which this application particularly refers, the ion concentration of the electrolyte remains a constant during charge and discharge.

It is a purpose of this invention to provide an electrochemical capacitor of type I as hereinbefore defined, which is simple to manufacture and requires the use of cheap materials only.

It is another purpose of this invention to provide an electrochemical capacitor having a higher specific capacitance than the prior art electrochemical capacitors.

It is a further purpose of this invention to provide an electrochemical capacitor having a higher energy density than the prior art electrochemical capacitors.

Other purposes and advantages of the invention will appear as the description proceeds.

### SUMMARY OF THE INVENTION

The invention provides an electrochemical capacitor which comprises positive and negative electrodes made of conducting p-dopable polyaniline, directly polymerized on carbon substrates, preferably carbon substrates having high porosity. Said substrates are preferably chosen from among carbon paper, graphite felts, carbon cloth, and glassy carbon foam, but other carbon substrates, particularly carbon fiber substrates, can be used. The capacitor of the invention further comprises a polymer electrolyte, which provides a conductive medium between the electrodes. The electrolyte layer is a polymer gel or solid electrolyte, comprising a polymer matrix and a ionic conductive compound. The polymer matrix is preferably selected from the group comprising polyvinyl alcohol, polyethylene glycol, polyvinyl pyrrolidone, polymethylmethacrylate, polyethylene oxide, polyacrylonitrile, polyvinylidene fluoride, poly(vinylidene fluoride-co-hexafluoropropylene) and combinations thereof. The ionic conducting compound preferably comprises a strong non-oxidative acid and a highly conducting stable salt. The acid is preferably selected from the group consisting of CH3SO3H, CF3SO3H, HBF₄, HPF₆, and combinations thereof, and the salt is preferably selected from the group consisting of LiCH₃SO₃, LiCF₃SO₃, LiBF₄, LiPF₆, R₄NCF₃SO₃, R₄NCH₃SO₃, R₄NBF₄, R₄NPF₆ (where R is methyl,ethyl, n-propyl or n-butyl) and combinations thereof.

The fibrous substrates of the capacitor of the invention preferably have a thickness comprised between 0.1 and 2 mm. Further, they preferably have a rectangular configuration, with sides from 1 to 5 cm. The amount of polyaniline electrodes having dimensions comprised in the aforesaid ranges is from 5 to 1000 mg.

The capacitor further comprises two outer conductive layers, preferably made of nickel foil, stainless steel foil, titanium foil, foiled PC (printed circuit board) pieces, a spacer for creating a gap between the electrodes, which is filled by the electrolyte, or for avoiding short circuit between electrodes, and sealing means.

The invention further comprises a method of making the capacitors defined above, which comprises effecting polymerization of the aniline over the substrate. Said polymerization may be chemical or electrochemical, depending on the sheet electrical resistance of the fibrous material. If the sheet resistance is high, e.g. above 1.5 Ohms/sq, only chemical polymerization should be used, because it has been found that electrochemical polymerization would give non-uniform coatings. If the sheet resistance is low, e.g. below 1.5 Ohms/sq, both electrochemical and chemical polymerization methods can be used.

### BRIEF DESCRIPTION OF THE DRAWINGS

In the drawings:

FIG. 1 is a schematic perspective view of a capacitor according to an embodiment of the invention;

FIGS. 2 and 3 are schematic cross-sections of the electrodes and electrolyte assembly according to two embodiments of the invention; and

FIG. 4 is a schematic flowsheet illustrating an embodiment of the method of the invention.

### DETAILED DESCRIPTION OF PREFERRED EMBODIMENTS

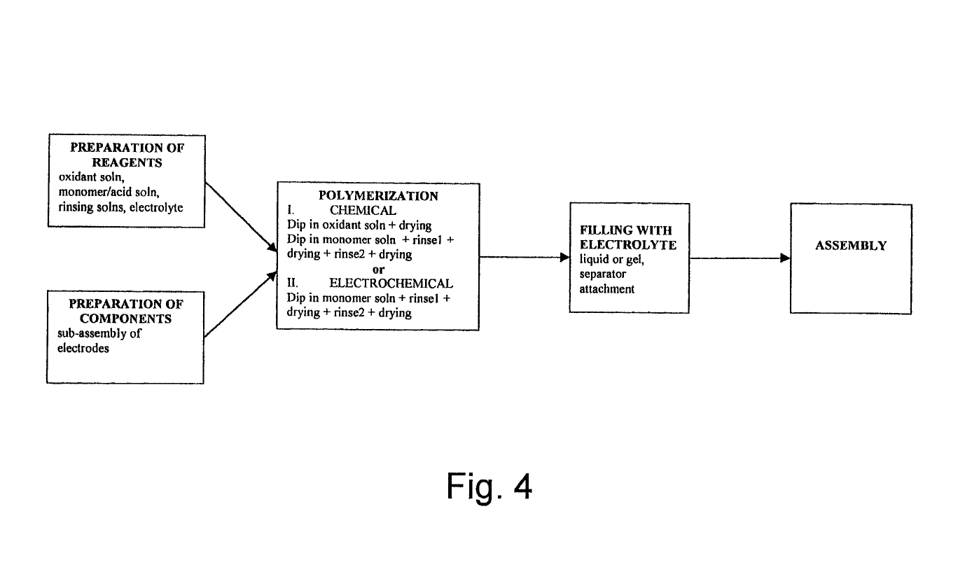

FIG. 4 illustrates the stages of the process according to an embodiment of the invention.

As a first step, the reagents that are necessary for the polymerization method chosen—chemical or electrochemical—are prepared. For both, a monomer/acid solution is required. The monomer is aniline. The acid is chosen from among those mentioned hereinbefore. The electrolyte is required in any case. Rinsing solutions are also prepared. The electrode substrates are provided, chosen from those set forth hereinbefore.

If a chemical polymerization is chosen, an oxidant solution is also prepared. The electrode substrates are dipped in said solution and dried. Then they are dipped in the monomer solution, kept at 0-10° for 30-120 min.. The oxidant and monomer react near the surface of the substrate forming the polymer directly on the substrate and partly in the solution. Then the substrate, with polymer on it, is rinsed, dried and rinsed again.

If an electrochemical polymerization is chosen, no oxidant solution is needed. The electrode substrates are dipped in the monomer solution, containing electrolytic salt or acid, and electric current is passed therethrough. The polymerization takes place at the positive electrode anode (working as oxidant). After polymerization, the substrates are rinsed and dried repeatedly, as in the chemical method.

In both cases, the electrodes are assembled with the electrolyte gel between them and the required separator/spacer attachment is provided, to constitute what can be called herein the electrode assembly.

Finally, the capacitor is completed by attaching the electrodes, by means of conductive cement, to two external foiled PCB (printed circuit boards) pieces as current collectors.

The following Table I illustrates the specific capacitance of polyaniline/carbon substrate electrodes in Farads per gram, for various substrates on which aniline has been polymerized with the methods indicated. N/A means that the method (chemical or electrochemical) not applicable to the substrate in question.

TABLE I

| | Substrate | | |
|---|---|---|---|
| | Aerogel carbon | | |
| Polymerization | paper | Graphite felt | |
| method | ˜3.5 Ohm/sq. | ˜0.6 Ohm/sq. | Stainless steel grid |
| Chemical | 340 | 370 | N/A |
| Electrochemical | N/A | 390 | 200 |

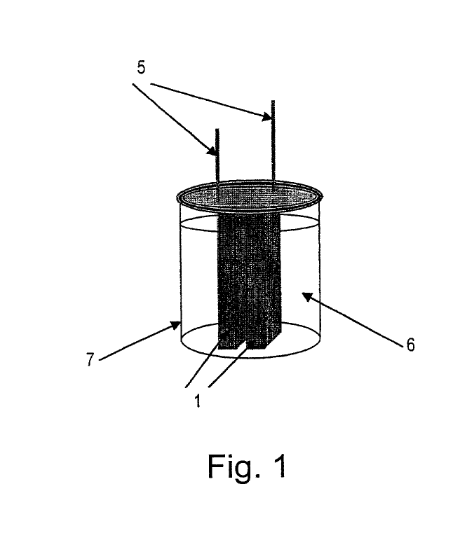

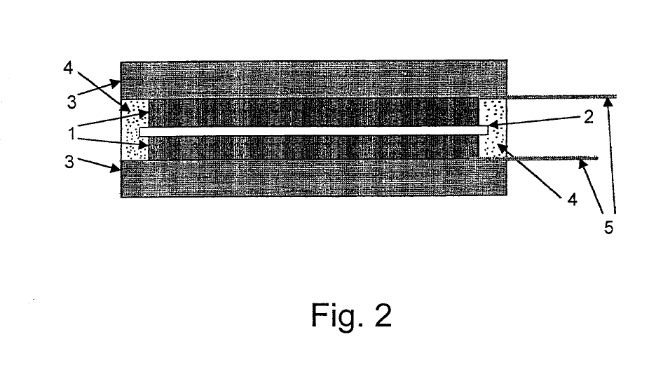

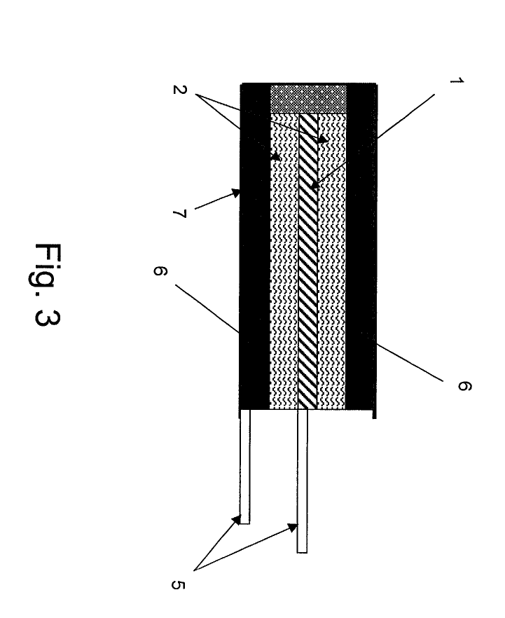

FIGS. 1 to 3 illustrate the general structure of the capacitor. FIG. 1 shows how the assembly of FIG. 2 (which is called here “the electrode assembly”) is placed in a liquid electrolyte cell 6, contained in can 7. The electrode assembly comprises (see FIG. 2) two electrodes indicated at 1, a layer of electrolyte 2 between them, and two outer foiled PCB sheets, to which are attached wires 5. Numeral 4 indicates an epoxy seal. FIG. 3 shows an alternative structure of the capacitor cell, consisting of positive electrode sheet 1 and negative electrode sheets 6, separator 2 and metal foil current collector 7, attached to the negative electrode sheets 6. The terminals 5 are attached to positive electrode sheet 1 and to current collector 7.

The following Examples are illustrative and not limitative.

### EXAMPLE 1

The electrodes for the capacitor cells were fabricated by chemical polymerization of aniline on the aerogel carbon paper sheets (Marketech International Inc., USA), thickness 0.25 mm, dimensions 2 cm×1.5 cm. Each electrode contained 15 mg of polyaniline. The electrodes were attached by conductive cement to the foiled PCB pieces as current collectors. Aqueous electrolyte gel was cast onto the electrodes and they were kept tightly together until the gel dried under ambient conditions. The cell had the following parameters: charging capacitance 5.9 F, operating voltage 0.8 V, ESR at 1 kHz, 0.7 Ohm. Specific capacitance and the energy density (per polyaniline mass unit) were estimated, and the results given in Table 2 in comparison with the prior art.

Carbon aerogel papers consist of a non-woven carbon paper impregnated with a carbon aerogel. Carbon aerogels are derived from the sol-gel polymerization of selected organic monomers in solution. After the solvent is removed, the resultant organic aerogel is pyrolized in an inert atmosphere to form a carbon aerogel. These materials have high porosity (>50 vol %). The pores are less than 100 nm in diameter and have surface area from 400 to 1000 m²/g. Stainless steel grid 200 mesh, wire 0.05 mm, hole 0.077 mm.

### Comparative Example 1

The electrodes of the capacitor cells were fabricated from two carbon aerogel paper sheets (Marketech International, Inc., USA), thickness 0.25 mm, dimensions 2 cm×1.5 cm. The electrodes were attached by conductive cement to the foiled PCB pieces as current collectors. Aqueous electrolyte gel was cast onto the electrodes and they were kept tightly together until the gel dried under ambient conditions. The cell had the following parameters: charging capacitance 1.1 F, operating voltage 1.2 V, ESR 0.8Ω at 1 kHz.

### Example 2

The electrodes for the capacitor cells were fabricated by electrochemical polymerization of aniline on the graphite felt sheets (Zoltek, Hungary), thickness 1.4 mm, dimensions 2 cm×1.5 cm. Electrochemical polymerization was carried out in the solution containing 0.5 mole/liter of aniline and 3 mole/liter of tetrafluoroboric acid in galvanostatic mode using potentiostat. Total charge passed was 250 Coulombs for both electrodes. After the polymerization the electrodes were rinsed in deionized water, then in ethanol and were dried in vacuum at 40° C. Each electrode contained 60 mg of polyaniline. The electrodes were supplied with wires and assembled together with porous polypropylene paper (Nippon Kodoshi Corp., Japan) between them as separator.

Nonaqueous electrolyte was prepared comprising a solution of electrolyte salt in organic solvent. The solvent is preferably selected from propylene carbonate, ethylenecarbonate, γ-butyrolactone and mixtures thereof. The electrolyte salt is preferably selected from tetralkylammonium salts of CH₃SO₃H, CF₃SO₃H, HBF₄, HPF₆, where alkyl is methyl, ethyl, n-propyl, n-butyl, and mixtures thereof.

The electrode stack was immersed in a polypropylene can filled with electrolyte comprising 1 mole/liter of tetraethylammonium tetrafluoroborate in propylene carbonate. The can cover was sealed with epoxy resin. This procedure was carried out in a glove box in a nitrogen gas atmosphere. The cell had the following parameters: charging capacitance 10.3 F, operating voltage 1.3 V, ESR 1.5Ω at 1 kHz.

### EXAMPLE 3

The electrodes for the capacitor cells were fabricated as described in Example 2 above. Nonaqueous polymer gel electrolyte comprises the electrolyte described in Example 2 that additionally contains 3-10 wt % of polyethylene oxide, polyethylene glycol, polyvinyl pyrrolidone, polyacrylonitrile, polymethylmethacrylate, poly(vinylidene fluoride), poly(vinylidene fluoride-co-hexafluoropropylene) and mixtures thereof. The electrodes were impregnated with nonaqueous electrolyte gel and were assembled together in a nitrogen gas glove box and were kept in the nitrogen stream overnight. The cell was encapsulated in epoxy resin. The cell had the following parameters: charging capacitance 8.8 F, operating voltage 1.3 V, ESR 2.8Ω at 1 kHz.

### EXAMPLE 4

A hybrid type capacitor cell was fabricated. A positive electrode, made of porous carbon substrate incorporating p-dopable aniline, was fabricated as described in Example 2. A negative electrode was made of activated carbon cloth (Calgon Carbon Corporation), thickness 0.5 mm, 20 mm×15 mm sheet, two negative electrode sheets and two sheets of porous polypropylene paper as separator. The positive electrode was attached to nickel wire terminal. The negative electrode sheets were attached to aluminum foil by means of conductive adhesive. Other activated carbon materials, e.g. felt or paper, could be used instead of the carbon cloth.

The electrode stack was immersed in a polypropylene can filled with electrolyte as described in Example 2. The cell had the following parameters: charging capacitance 4.1 F, operating voltage 2.3 V, ESR 1.2Ω at 1 kHz.

### Comparative Example 2

The electrodes of the capacitor cell were fabricated as described in Comparative Example 1 above. The terminal wires were attached to the electrodes by means of conductive silver epoxy resin. The electrodes were impregnated with non-aqueous polymer gel electrolyte as described in Example 3 above, were assembled together in a nitrogen glove box and were kept in the glove box overnight; The cell was encapsulated in epoxy resin. The cell had the following parameters: charging capacitance 0.7 F, operating voltage 2.4 V, ESR 3.6Ω at 1 kHz.

The following Table II compares the properties of the capacitors made according to this invention with those of capacitors according to two of the prior patents mentioned hereinbefore.

TABLE II

| | | | | | | Energy |
|---|---|---|---|---|---|---|
| | | | | | Specific | Density |
| Source ref. | System/type | Voper, V | Cap. F | ESR Ω | Cap. F/g | Wh/kg |
| USP 5,442,197 | PPY non-aq. | 1.685 | 0.81 | — | 25.3 | 9 |
| USP 5,284,723 | PPY non-aq. | 1.5 | 12.3 | 12 | 77 | 23.8 |
| This invention | PANI solid aq. | 0.8 | 5.9 | 0.7 | 196 | 14.8 |
| | PANI non-aq. | 1.3 | 10.3 | 1.5 | 86 | 20.2 |
| | PANI solid | 1.3 | 8.8 | 2.8 | 73 | 17.1 |
| | non-ag. | | | | | |
| | PANI hybrid | 2.3 | 4.1 | 1.2 | 68 | 50 |
| | non-ag. | | | | | |

In Table II, PPY means polypyrrole, PANI means polyaniline, Voper means operating voltage, and ESR means equivalent series resistance. The capacitors according to the prior patents were prepared according to Example 2 of each.

While embodiments of the invention has been described by way of illustration, it should be understood that it is not limiting and that many variations, modifications and adaptations can be carried out in the product and process of the invention, without exceeding the scope of the claims.

1. Polymer electrochemical capacitor, which comprises positive and negative electrodes made of porous carbon substrates incorporating conducting p-dopable polyaniline, and an electrolyte layer, which provides a conductivity medium between the electrodes.

2. Capacitor according to claim 1, wherein the substrates are fibrous substrates.

3. Capacitor according to claim 1, wherein the substrates are chosen from the group consisting of carbon paper, graphite felts, carbon cloth, and glassy carbon foam.

4. Capacitor according to claim 1, wherein the electrolyte layer is a polymer gel or solid electrolyte, comprising a polymer matrix and a ionic conductive compound.

5. Capacitor according to claim 4, wherein the polymer matrix is selected from the group consisting of polyvinyl alcohol, polyethylene glycol, polyvinyl pyrrolidone, polymethylmethacrylate, polyethylene oxide, polyacrylonitrile, polyvinylidene fluoride, poly(vinylidene fluoride-co-hexafluoropropylene) and combinations thereof.

6. Capacitor according to claim 1, wherein the ionic conducting compound comprises an acid selected from the group consisting of CH₃SO₃CH, CF₃SO₃H, HBF₄, HPF₆ and combinations thereof, and a salt selected from the group consisting of LiCH₃SO₃, LiCF₃SO₃, LiBF₄, LiBF₆, R₄NCF₃SO₃, R₄NCH₃SO₃, R₄NBF₄, R₄NPF₆ (where R is methyl,ethyl, n-propyl or n-butyl) and combinations thereof.

7. Capacitor according to claim 2, wherein the fibrous substrates have a thickness comprised between 0.1 and 2 mm.

8. Capacitor according to claim 2, wherein the substrates have a rectangular configuration, with sides from 1 to 5 cm.

9. Capacitor according to claim 1, wherein the amount of polyaniline electrodes is from 5 to 1000 mg.

10. Capacitor according to claim 1, further comprising two outer conductive layers.

11. Capacitor according to claim 1, further comprising a sealant.

12. Capacitor according to claim 1, comprising a positive electrode made of porous carbon substrate incorporating p-dopable polyaniline, a negative electrode made of two sheets of activated carbon material and an electrolyte layer, which provides a conductivity medium between the electrodes.

13. Capacitor according to claim 12, wherein the sheets of activated carbon material are chosen from the group consisting of cloth, felt and paper.

14. Method of making a polymer electrochemical capacitor, which comprises effecting polymerization of aniline over fibrous carbon substrate.

15. Method according to claim 14, wherein the polymerization is chosen from among chemical or electrochemical polymerization.

16. Method according to claim 15, wherein the polymerization is chemical if the sheet electrical resistance of the fibrous material is above 1.5 Ohms/sq.
